(19) United States
(12) Patent Application Publication
(10) Pub. No.: US 2022/0335554 A1
(43) Pub. Date: Oct. 20, 2022

(54) DISTRIBUTED LEDGER SYSTEM FOR ASSET MANAGEMENT AND CORRESPONDING FINANCIAL INSTRUMENT APPLICATIONS

(71) Applicant: KOCH INDUSTRIES, INC., Wichita, KS (US)

(72) Inventors: Tim DAVIES, Wichita, KS (US); Michael KRULJAC, Roswell, GA (US); Stephen MACKENZIE, Wichita, KS (US)

(21) Appl. No.: 17/634,687

(22) PCT Filed: Sep. 2, 2020
(86) PCT No.: PCT/IB2020/058171

§ 371 Date: Feb. 11, 2022

Related U.S. Application Data
(60) Provisional application No. 62/899,152, filed on Sep. 12, 2019.

(51) Int. Cl. G06Q 50/18; G06Q 20/38; G06F 21/62

(52) U.S. Cl. CPC G06Q 50/184; G06Q 20/389; G06F 21/6245; G06F 2221/2141

(57) ABSTRACT

Various embodiments provide an asset management distributed ledger system for capturing, storing, and providing access to asset information/data. For example, asset information/data and/or an evaluation value corresponding to an IP asset may be accessed from a distributed ledger of a distributed ledger system. The asset information/data and/or evaluation value may be leveraged to perform one or more tasks corresponding to a financial instrument related to (e.g., incorporating) the IP asset.

### RELATED APPLICATION

This application claims priority to provisional Application Ser. No. 62/899,152, filed on Sep. 12, 2019, which is incorporated by reference in its entirety.

### FIELD

Various embodiments relate generally to distributed ledgers and asset management. For example, an example embodiment relates to a distributed ledger system for storing and providing information/data corresponding to managed assets.

### BACKGROUND

Asset management can be a time-intensive process. For non-tangible assets (e.g., intellectual property (IP) assets, and/or the like), asset management becomes more difficult. For instance, poor visibility, transparency, and accuracy of IP data causes IP asset management to be a difficult and time-consuming process. For example, IP asset due diligence processes often rely on determinations made on multiple siloed, incomplete data sources.

Through applied effort and ingenuity, various embodiments of the present invention satisfy at least the above-mentioned needs as discussed in greater detail herein.

### BRIEF SUMMARY OF SOME EXAMPLE EMBODIMENTS

Various embodiments provide methods, apparatuses, computer program products, systems, and/or the like for executing in association with a distributed ledger system. In various embodiments, the distributed ledger system comprises a distributed ledger and an interactive user interface (IUI) (e.g., executing on a user computing entity) via which users may provide information/data to be recorded/stored by the distributed ledger and access information/data stored in the distributed ledger. In various embodiments, the information/data recorded and/or stored by the distributed ledger may correspond to one or more IP assets. As used herein, the term IP asset may indicate an individual IP asset, unrelated plurality of IP assets, family of IP assets, and/or portfolio of IP assets, as appropriate for the application. In various embodiments, a plurality of unrelated IP assets is a group of IP assets that are not related via priority, common inventive entity, subject matter, and/or the like. In an example embodiment, the plurality of IP assets may have a common assignee, licensee, and/or the like. In various embodiments, the distributed ledger system comprises a permissioning and/or access control module for controlling the access of information/data stored in the distributed ledger. Appendix A provides further detail regarding the receiving, storing, and controlling of access to information/data corresponding to one or more IP assets with respect to the distributed ledger. In various embodiments, the information/data stored in the distributed ledger corresponding to one or more IP assets may be evaluated to determine an evaluation value corresponding to an IP asset. Various example embodiments of determining an evaluation value corresponding to an IP asset and corresponding apparatus, systems, and computer program products are described in more detail in Appendix B. The evaluation value and/or information/data corresponding to the IP asset may then be used to value the IP asset as part of one or more financial instruments, determine risk associated with the IP asset as part of one or more financial instruments, and/or the like. In various embodiments, the one or more financial instruments may include secured assets, backed securities, licensing of an IP asset, securitizing a license stream (e.g., similar to a mortgage-backed security backed by an IP asset), one or more financial derivatives, and/or the like. In an example embodiment, the value, risk, and/or the like corresponding to an IP asset may be based on a category corresponding to the IP asset, wherein the categories comprise prime IP assets (e.g., having a good and steady corresponding revenue stream), sub-prime IP assets (e.g., having a low, unreliable, and/or unknown corresponding revenue stream), and unknown IP asset (e.g., having no corresponding revenue stream). In various embodiments, the revenue stream corresponding to an IP asset include licensing revenue, sales revenue, savings, and/or the like corresponding to the IP asset.

In accordance with one aspect, a method is provided. In one embodiment, the method comprises receiving and recording, by one or more node computing entities, asset information/data in a distributed ledger of a distributed ledger system. The asset information/data corresponds to an IP asset. The method further comprises providing, by one or more node computing entities, asset information/data for use in determining an evaluation value of the IP asset; recording, by the one or more node computing entities, the evaluation value of the IP asset to the distributed ledger; providing, by the one or more node computing entities, at least a portion of the asset information/data and/or the evaluation value of the IP asset for use in performing one or more tasks corresponding to a financial instrument related to the IP asset; and receiving and recording, by the one or more node computing entities, instrument information/data corresponding to the financial instrument related to the IP asset.

In an example embodiment, the financial instrument is a secured asset, backed security, licensing of an IP asset, securitizing a license stream, or a financial derivative. In an example embodiment, the method further comprises performing one or more transactions corresponding to a financial instrument via a smart contract executing in the distributed ledger system. In an example embodiment, the IP asset is an individual IP asset, an unrelated plurality of IP assets, a family of IP assets, or a portfolio of IP assets. In an example embodiment, the one or more tasks corresponding to the financial instrument comprise at least one of valuing the IP asset as part of one or more financial instruments or determining risk associated with the IP asset as part of one or more financial instruments.

According to another aspect, a method is provided. In an example embodiment, the method comprises accessing asset information/data and/or an evaluation value corresponding to an IP asset from a distributed ledger of a distributed ledger system; and leveraging the asset information/data and/or evaluation value to perform one or more tasks corresponding to a financial instrument related to (e.g., incorporating) the IP asset (and/or a revenue stream corresponding thereto).

In accordance with yet another aspect, a computing system is provided. In an example embodiment, the computing system is a node of a distributed ledger system. The computing system comprises a non-transitory computer readable storage medium and one or more processors, the computing system configured to receive and record asset information/data in a distributed ledger of a distributed ledger system. The asset information/data corresponds to an IP asset. The computing system is further configured to provide asset information/data for use in determining an evaluation value of the IP asset; record the evaluation value of the IP asset to the distributed ledger; provide at least a portion of the asset information/data and/or the evaluation value of the IP asset for use in performing one or more tasks corresponding to a financial instrument related to the IP asset; and receive and record instrument information/data corresponding to the financial instrument related to the IP asset.

In accordance with yet another aspect, a computing system is provided. The computing system comprises a non-transitory computer readable storage medium and one or more processors, the computing system configured to access asset information/data and/or an evaluation value corresponding to an IP asset from a distributed ledger of a distributed ledger system; and leverage the asset information/data and/or evaluation value to perform one or more tasks corresponding to a financial instrument related to (e.g., incorporating) the IP asset (and/or a revenue stream thereof).

In accordance with another aspect, a computer program product for is provided. The computer program product may comprise a non-transitory computer readable medium having computer program instructions stored therein, the computer program instructions when executed by a processor, cause the processor to receive and record asset information/data in a distributed ledger of a distributed ledger system. The asset information/data corresponds to an IP asset. The computing system is further configured to provide asset information/data for use in determining an evaluation value of the IP asset; record the evaluation value of the IP asset to the distributed ledger; provide at least a portion of the asset information/data and/or the evaluation value of the IP asset for use in performing one or more tasks corresponding to a financial instrument related to the IP asset; and receive and record instrument information/data corresponding to the financial instrument related to the IP asset.

In accordance with still another aspect, a computer program product for is provided. The computer program product may comprise a non-transitory computer readable medium having computer program instructions stored therein, the computer program instructions when executed by a processor, cause the processor to access asset information/data and/or an evaluation value corresponding to an IP asset from a distributed ledger of a distributed ledger system; and leverage the asset information/data and/or evaluation value to perform one or more tasks corresponding to a financial instrument related to (e.g., incorporating) the IP asset (and/or a revenue stream thereof).

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A is a diagram of a system that can be used to practice various embodiments of the present invention;

FIG. 1B is a diagram of another system that can be used to practice various embodiments of the present invention;

FIG. 2 is a schematic of a node computing entity in accordance with certain embodiments of the present invention;

FIG. 3 is a schematic of another node computing entity in accordance with certain embodiments of the present invention;

FIG. 4 is a schematic illustration of the distributed ledger system, in accordance with an example embodiment of the present invention; and

FIG. 5 provides a flowchart illustrating processes, steps, procedures, operations, and/or the like for utilizing information/data and/or an evaluation value corresponding to an IP asset to perform one or more financial instrument-related functions, in accordance with an example embodiment of the present invention.

### DETAILED DESCRIPTION OF SOME EXAMPLE EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### I. BRIEF OVERVIEW

Various embodiments provide and/or utilize an asset management distributed ledger system, referred to as the distributed ledger system herein. In various embodiments, the distributed ledger system is configured for capturing, storing, and providing access to asset information/data corresponding to one or more assets. In various embodiments, the one or more assets are IP assets and/or other intangible assets. The distributed ledger system is configured for capturing and storing asset information/data such as assignment information/data, innovation disclosures (e.g., IDRs), grant/issue information/data, maintenance and/or expiry information/data, search and/or due diligence investigation information/data, licensing/sale information/data, evaluation values, and/or the like. For example, the distributed ledger system may capture and store asset information/data that provides a complete record of an asset. The distributed ledger system is further configured to provide access to the asset information/data via an IUI or search function of the distributed ledger system. In various embodiments, the distributed ledger system is a blockchain system. A blockchain system is a particular implementation of a distributed ledger system—the terms blockchain, blockchain system, distributed ledger, distributed ledger system, ledger, and/or the like are used herein interchangeably. The evaluation value and/or asset information/data corresponding to an IP asset (or other intangible asset) may then be used to value the IP asset as part of one or more financial instruments and/or determine risk associated with the IP asset as part of one or more financial instruments. In various embodiments, the one or more financial instruments may include secured assets, backed securities, licensing of an IP asset, securitizing a license stream (e.g., similar to a mortgage-backed security backed by an IP asset), one or more financial derivatives, and/or the like. In an example embodiment, the value, risk, and/or the like corresponding to an IP asset may be based on a category corresponding to the IP asset, wherein the categories comprise prime IP assets (e.g., having a good and steady corresponding revenue stream), sub-prime IP assets (e.g., having a low, unreliable, and/or unknown corresponding revenue stream), and unknown IP asset (e.g., having no corresponding revenue stream). In various embodiments, the revenue stream corresponding to an IP asset include licensing revenue, sales revenue, savings, and/or the like corresponding to the IP asset.

In various embodiments, a distributed ledger is a data store that is stored by a plurality of nodes that may be geographically separated. In various embodiments, each node of a distributed ledger may comprise one or more node computing entities. The copies of the distributed ledger are stored by the plurality of nodes of the distributed leger. To ensure the validity of instances of information/data stored in the distributed ledger, to ensure transactions and/or value exchanges are properly and appropriately carried out, and/or to ensure that events (e.g., instances of information/data, transactions and/or value exchanges, and/or the like) written to the distributed ledger are in the appropriate format, a consensus and/or voting process may be used.

### II. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for instance, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of a data structure, apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to step/operation diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For instance, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### III. EXEMPLARY SYSTEM ARCHITECTURE

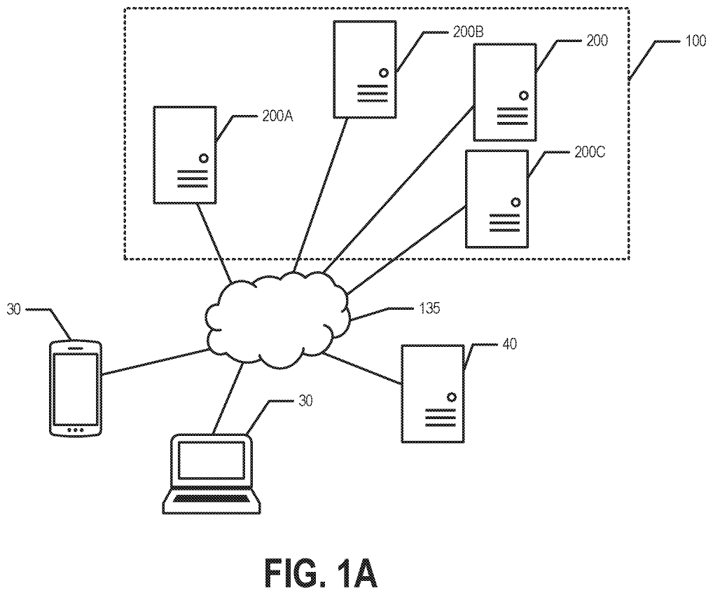

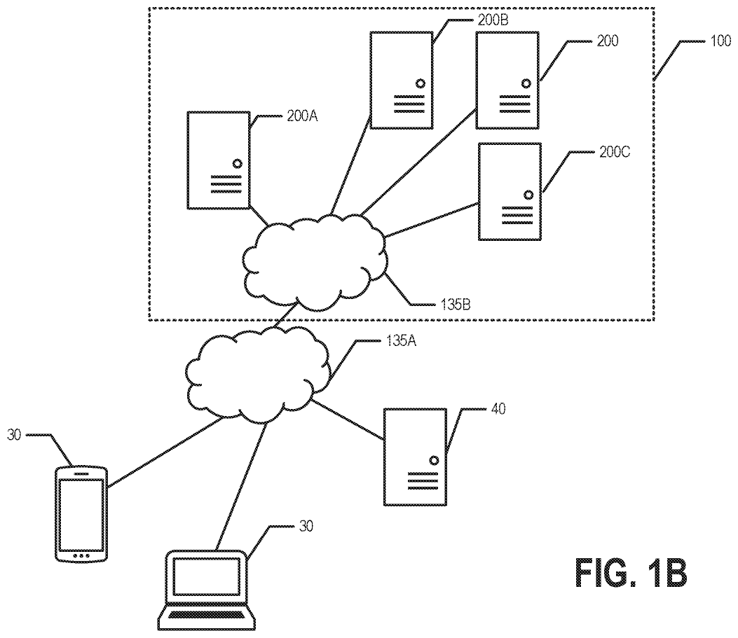

FIG. 1A provides an illustration of a system that can be used in conjunction with various embodiments of the present invention. As shown in FIG. 1A, the system may comprise a distributed ledger system 100 comprising a plurality of node computing entities 200. In various embodiments, the node computing entities 200 are nodes of the distributed ledger of the distributed ledger system 100. As shown in FIG. 1A, the system may further comprise one or more user computing entities 30, one or more provider computing entities 40, one or more networks 135, and/or the like. FIG. 1B provides an illustration of another system that can be used in conjunction with various embodiments of the present invention. As shown in FIG. 1B, the system may comprise a distributed ledger system 100 comprising a plurality of node computing entities 200, 200′ and one or more internal and/or private networks 135B. For example, in an example embodiment, the distributed ledger system 100 comprises a two or more node computing entities 200, 200′ in communication with one another via an internal and/or private network 135B. For instance, the internal and/or private network 135B may be an internal or private network. As shown in FIG. 1B, the system may further comprise one or more user computing entities 30, one or more provider computing entities 40, one or more other and/or external networks 135A, and/or the like. For example, the other and/or external network 135A may be external, public, and/or a different network from the internal and/or private network 135B. For instance, the external network 135A may be the Internet. Each of the components of the system may be in electronic communication with, for example, one another over the same or different wireless or wired networks 135, 135A, 135B including, for instance, a wired or wireless Personal Area Network (PAN), Local Area Network (LAN), Metropolitan Area Network (MAN), Wide Area Network (WAN), or the like. Additionally, while FIGS. 1A and/or 1B illustrate certain system entities as separate, standalone entities, the various embodiments are not limited to this particular architecture.

a. Exemplary Node Computing Entity

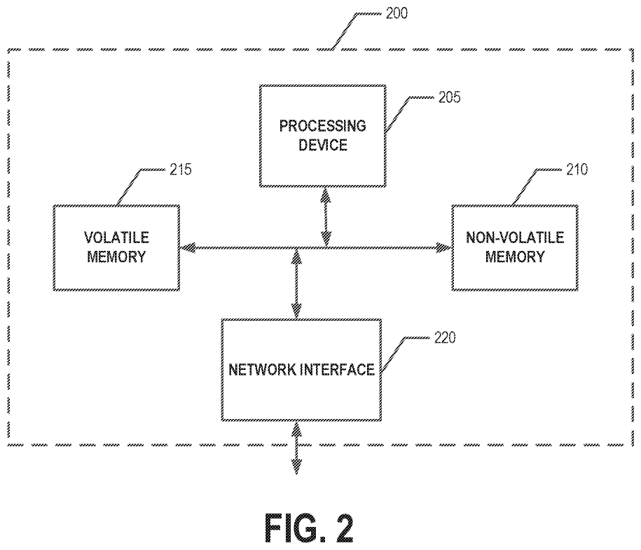

FIG. 2 provides a schematic of a node computing entity 200 according to one embodiment of the present invention. In general, the terms node computing entity, computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, relays, routers, network access points, base stations, the like, and/or any combination of devices or entities adapted to perform the functions, operations, and/or processes described herein. Such functions, operations, and/or processes may include, for instance, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

In various embodiments, a node computing entity 200 is operated by and/or on behalf of an entity, individual, organization, department of a corporation, and/or the like that is a member of the distributed ledger system 100. In an example embodiment, some or all of the node computing entities 200 are nodes of the distributed ledger of the distributed ledger system 100. For example, a node of a distributed ledger may store a copy of the distributed ledger, participate in consensus and/or voting functions for the distributed ledger, supply instances of asset information/data for recording in the distributed ledger, access instances of information/data from the distributed ledger, and/or the like.

As indicated, in one embodiment, the node computing entity 200 may also include one or more network and/or communications interfaces 220 for communicating with various computing entities, such as by communicating data, content, information, and/or similar terms used herein interchangeably that can be transmitted, received, operated on, processed, displayed, stored, and/or the like. For instance, the node computing entity 200 may communicate with other node computing entities 200, 200′, one or more user computing entities 30, and/or the like.

As shown in FIG. 2, in one embodiment, the node computing entity 200 may include or be in communication with one or more processing elements 205 (also referred to as processors, processing circuitry, and/or similar terms used herein interchangeably) that communicate with other elements within the node computing entity 200 via a bus, for instance. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the node computing entity 200 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably may refer to a structured collection of records or information/data that is stored in a computer-readable storage medium, such as via a relational database, hierarchical database, and/or network database.

In one embodiment, the node computing entity 200 may further include or be in communication with volatile media (also referred to as volatile storage, memory, memory storage, memory circuitry and/or similar terms used herein interchangeably). In one embodiment, the volatile storage or memory may also include one or more volatile storage or memory media 315 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for instance, the processing element 305. Thus, the databases, database instances, database management system entities, data, applications, programs, program modules, scripts, source code, object code, byte code, compiled code, interpreted code, machine code, executable instructions, and/or the like may be used to control certain aspects of the operation of the node computing entity 200 with the assistance of the processing element 205 and operating system.

As indicated, in one embodiment, the node computing entity 200 may also include one or more network and/or communications interfaces 220 for communicating with various computing entities, such as by communicating data, content, information, and/or similar terms used herein interchangeably that can be transmitted, received, operated on, processed, displayed, stored, and/or the like. For instance, the node computing entity 200 may communicate with computing entities or communication interfaces of other node computing entities 200, 200′, and/or the like.

As indicated, in one embodiment, the node computing entity 200 may also include one or more network and/or communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the node computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The computing entity 200 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the node computing entity's 200 components may be located remotely from other node computing entity 200 components, such as in a distributed system. Furthermore, one or more of the components may be combined and additional components performing functions described herein may be included in the node computing entity 200. Thus, the node computing entity 200 can be adapted to accommodate a variety of needs and circumstances.

In example embodiments, the node computing entity 200 may be in communication with one or more other node computing entities 200, 200′, one or more provider computing entities 40, and/or one or more user computing entities 30. In example embodiments, the node computing entity 200 may be in communication with one or more other node computing entities 200, 200′ configured for submitting instances of information/data; validating instances of information/data; accessing and/or providing access to instances of information/data; managing time dependent values of data assets within the distributed ledger (e.g., instances of information/data), tokens, and/or data access costs; performing consensus processing; storing a copy of a distributed ledger; and/or the like. In an example embodiment, the distributed ledger is a blockchain.

b. Another Exemplary Node Computing Entity

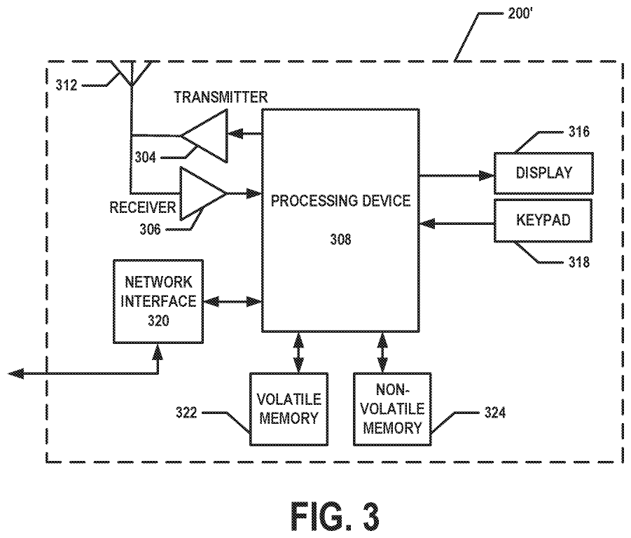

FIG. 3 provides an illustrative schematic representative of another node computing entity 200′ that can be used in conjunction with embodiments of the present invention. As shown in FIG. 3, a node computing entity 200′ can include an antenna 312, a transmitter 304 (e.g., radio), a receiver 306 (e.g., radio), and a processing element 308 that provides signals to and receives signals from the transmitter 304 and receiver 306, respectively. The signals provided to and received from the transmitter 304 and the receiver 306, respectively, may include signaling information/data in accordance with an air interface standard of applicable wireless systems to communicate with various entities, such as another node computing entity 200, 200′, one or more user computing entities 30, and/or the like. In this regard, the node computing entity 200′ may be capable of operating with one or more air interface standards, communication protocols, modulation types, and access types. More particularly, the node computing entity 200′ may operate in accordance with any of a number of wireless communication standards and protocols. In a particular embodiment, the node computing device 200′ may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the node computing entity 200′ can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The node computing entity 200′ can also download changes, add-ons, and updates, for instance, to its firmware, software (e.g., including executable instructions, applications, program modules), and operating system.

According to one embodiment, the node computing entity 200′ may include location determining aspects, devices, modules, functionalities, and/or similar words used herein interchangeably. For example, the node computing entity 200′ may include outdoor positioning aspects, such as a location module adapted to acquire, for instance, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the computing entity's 200′ position in connection with a variety of other systems, including cellular towers, Wi-Fi access points, and/or the like. Similarly, the node computing entity 200′ may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The node computing entity 200′ may also comprise a user interface device comprising one or more user input/output interfaces (e.g., a display 316 and/or speaker/speaker driver coupled to a processing element 308 and a touch screen, keyboard, mouse, and/or microphone coupled to a processing element 308). For instance, the user output interface may be configured to provide an application, browser, user interface, interface, dashboard, screen, webpage, page, and/or similar words used herein interchangeably executing on and/or accessible via the node computing entity 200′ to cause display or audible presentation of information/data and for user interaction therewith via one or more user input interfaces. The user input interface can comprise any of a number of devices allowing the node computing entity 200′ to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the node computing entity 200′ and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the node computing entity 200′ can collect information/data, user interaction/input, and/or the like.

The node computing entity 200′ can also include volatile storage or memory 322 and/or non-volatile storage or memory 324, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the node computing entity 200′.

In example embodiments, the node computing entity 200′ may be in communication with one or more other node computing entities 200, 200′, one or more provider computing entities 40, and/or one or more user computing entities 30. In example embodiments, the node computing entity 200′ may be in communication with one or more other node computing entities 200, 200′ configured for submitting instances of information/data; validating instances of information/data; accessing and/or providing access to instances of information/data; managing time dependent values of data assets within the distributed ledger (e.g., instances of information/data), tokens, and/or data access costs; performing consensus processing; storing a copy of a distributed ledger; and/or the like. In an example embodiment, the distributed ledger is a blockchain.

c. Exemplary User Computing Entity

In an example embodiment, a user computing entity 30 may be a computing entity configured for user interaction (e.g., via one or more user interface devices thereof) for providing and/or accessing one or more instances of asset information/data to/from the distributed ledger. In an example embodiment, a user computing entity 30 may configured to generate and/or determine an evaluation value corresponding to an IP asset (possibly based on corresponding asset information/data stored in the distributed ledger and/or other information/data) and provide an evaluation value for the IP asset to the distributed ledger (e.g., for recording therein). In various embodiments, a user may be a person interacting with a user computing entity 30 (e.g., via the user interface devices thereof) or a machine user (e.g., an application, service, and/or the like operating on the user computing entity 30). In various embodiments, the user computing entity 30 may be a computing entity external to the distributed ledger (e.g., the user computing entity 30 is not a node of the distributed ledger). In an example embodiment, a user computing entity 30 may be a node computing entity 200, 200′.

In an example embodiment, a user computing entity 30 may be in communication with one or more node computing entities 200, 200′ and/or one or more provider computing entities 40 via one or more wired or wireless networks 135. In one embodiment, the user computing entity 30 may include one or more components that are functionally similar to those of a node computing entity 200, 200′. For example, in one embodiment, a user computing entity 30 may include: (1) a processing element that communicates with other elements via a system interface or bus; (2) a user interface comprising one or more user interface devices (e.g., display, touchscreen display, hard or soft keyboard, mouse, and/or other user input and/or output devices); (3) transitory and non-transitory memory; and (4) a network and/or communications interface configured to communicate via one or more wired or wireless networks 135. For instance, the user computing entity 30 may receive user input (e.g., via the user input interface thereof) and provide (e.g., transmit) an indication of the user input to one or more node computing entities 200, 200′ (e.g., via the network and/or communications interface). In another example, the user computing entity 30 may receive asset information/data provided by one or more node computing entities 200, 200′ and provide at least a portion of the received asset information/data via an IUI provided via the user interface.

d. Exemplary Provider Computing Entity

In an example embodiment, a provider computing entity 40 may be a computing entity operated by and/or on behalf of a member entity of the distributed ledger system that is not a node of the distributed ledger. For example, a provider computing entity 40 may be a computing entity that stores and/or operates one or more member entity systems, such as docketing programs, financial programs, enterprise resource planning (ERP) systems, and/or the like, used by a member entity. In an example embodiment, a provider computing entity 40 is a computing entity operated by and/or on behalf of a provider of financial services (e.g., bank, credit union, automated clearing house (ACH), credit services organization, investment services organization, and/or the like). In various embodiments, the financial services provider may or may not be a member entity of the distributed ledger.

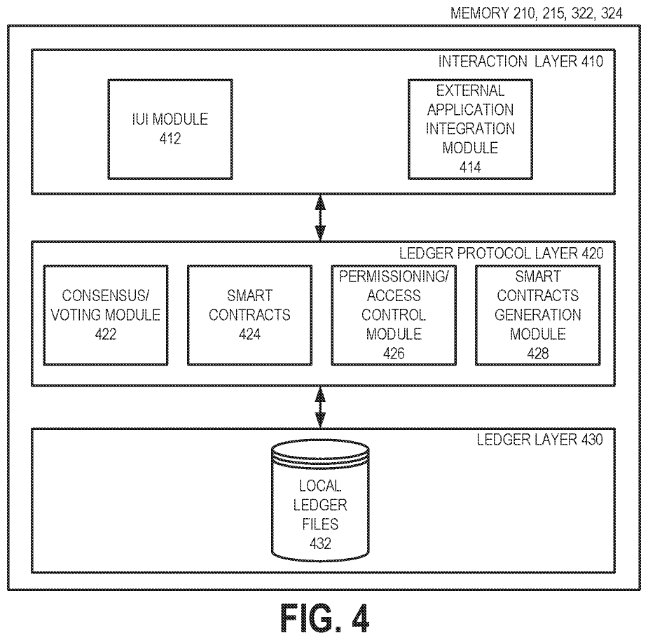

In various embodiments, a provider computing entity 40 may interact with the distributed ledger and/or the distributed ledger system 100 via an external application integration module 414 (shown in FIG. 4). For example, member entity systems, such as docketing programs, financial programs, ERP systems, patent application information retrieval systems, and/or the like, may provide asset information/data to and/or access information/data from the distributed ledger. For example, a provider computing entity 40 the external application integration module 414 may provide for integration between member entity systems (e.g., operating on provider computing entities 40) and the distributed ledger system 100 such that member entities may customize their own IP management systems and/or IUIs provided to corresponding users while still experiencing the advantages of the distributed ledger system 100. In an example embodiment, a provider computing entity 40 operated by a financial services provider may access the distributed ledger to access asset information/data corresponding to an IP asset (or other intangible asset) for valuing the IP asset as part of one or more financial instruments and/or determining risk associated with the IP asset as part of one or more financial instruments. In various embodiments, the one or more financial instruments may include secured assets, backed securities, licensing of an IP asset, securitizing a license stream (e.g., similar to a mortgage-backed security backed by an IP asset), one or more financial derivatives, and/or the like. In an example embodiment, the value, risk, and/or the like corresponding to an IP asset may be based on a category corresponding to the IP asset, wherein the categories comprise prime IP assets (e.g., having a good and steady corresponding revenue stream), sub-prime IP assets (e.g., having a low, unreliable, and/or unknown corresponding revenue stream), and unknown IP asset (e.g., having no corresponding revenue stream). In various embodiments, the revenue stream corresponding to an IP asset include licensing revenue, sales revenue, savings, and/or the like corresponding to the IP asset. In an example embodiment, the provider computing entity 40 may provide instrument information/data corresponding to one or more financial instruments corresponding to and/or incorporating one or more IP assets (and/or portions thereof) to the distributed ledger system 100 for recording into the distributed ledger.

In an example embodiment, a provider computing entity 40 may be in communication with one or more node computing entities 200, 200′ and/or one or more user computing entities 30 via one or more wired or wireless networks 135. In one embodiment, the provider computing entity 40 may include one or more components that are functionally similar to those of a node computing entity 200, 200′. For instance, in one embodiment, a provider computing entity 40 may include: (1) a processing element that communicates with other elements via a system interface or bus; (2) one or more user interface devices (e.g., display, touchscreen display, hard or soft keyboard, mouse, and/or the like); (3) transitory and non-transitory memory; and (4) a network and/or communications interface configured to communicate via one or more wired or wireless networks 135.

e. Exemplary Networks

In one embodiment, any two or more of the illustrative components of the architecture of FIGS. 1A and/or 1B may be configured to communicate with one another via respective communicative couplings to one or more networks 135. The networks 135 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 135 may have any suitable communication range associated therewith and may include, for instance, global networks (e.g., the Internet), MANs, WANs, LANs, or PANs. In addition, the networks 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

### IV. EXEMPLARY SYSTEM OPERATION

FIG. 4 illustrates an example schematic diagram of modules of the distributed ledger system 100 stored in memory 210, 215, 322, 324 of a node computing entity 200, 200′. Each of the modules provide functionality to the distributed ledger system 100. The interaction layer 410 comprises the IUI module 412 and external application integration module 414. The IUI module 412 comprises executable computer code that, when executed by a processing element or device (e.g., 205, 308), causes a user interface of the node computing entity 200, 200′ and/or a user interface of a user computing entity 30 to provide an IUI for a user to provide asset information/data and/or for a user to view and/or consume asset information/data. The external application integration module 414 is configured to provide an access point to the distributed ledger system 100 for applications external to the distributed ledger system 100 (e.g., machine users, and/or other applications). For example, the external application integration module 414 may expose one or more application programming interfaces (APIs) that may allow external applications (e.g., docketing programs; financial programs; systems, applications, and programs (SAP) and/or ERP systems; parsing programs; and/or the like) to access various elements of the distributed ledger system 100. For example, a provide computing entity 40 may interact with the distributed leger system 100 and/or one or more node computing entities 200, 200′ via the external application integration module 414 for accessing asset information/data and/or an evaluation value for an IP asset from the distributed ledger system 100 for valuing the IP asset as part of one or more financial instruments and/or determining risk associated with the IP asset as part of one or more financial instruments; and/or for providing instrument information/data corresponding to an IP asset to the distributed ledger system 100.

The ledger protocol layer 420 comprises modules configured to act as intermediaries between the IUI module 412 and the distributed ledger itself. For instance, the ledger protocol layer 420 may comprise a consensus/voting module 422, one or more smart contracts 424 and/or a module configured for generating smart contracts, a permissioning/access control module 426, and/or the like. For example, the consensus/voting module 422 may be configured to perform a consensus and/or voting process on instances of asset information/data to be recorded/stored to the distributed ledger (e.g., written to the local ledger files 432). In various embodiments, the permissioning/access control module 426 may be configured to control which users are provided with access to which instances of information/data. In various embodiments, the permissioning/access control module 426 may consider a user identifier, member entity identifier, and/or role associated with a user profile; an asset identifier, an asset type, an instance of information/data type, and/or an asset status indicator corresponding to an asset and/or a particular instance of asset information/data to determine which users are able to access the particular instance of asset information/data. Thus, the modules of the ledger protocol layer 420 control the recording of information/data to the distributed ledger and the access of information/data from the distributed ledger.

In various embodiments, the ledger layer 430 comprises local ledger files 432. The local ledger files 432 comprise a copy of the distributed ledger stored by the node computing entity 200.

In various embodiments, the distributed ledger system 100 provides transparent, accurate, and comprehensive asset information/data. For example, various embodiments provide enhanced traceability of assets through the asset lifecycle in the overall ecosystem. For example, various embodiments provide enhanced traceability of IP assets through the IP asset lifecycle in the overall IP ecosystem. Various embodiments provide improved transactions, minimize business, legal, and/or reputational risk, and provide improved accessibility to IP asset information/data. Various embodiments improve the quality of asset information/data across the overall ecosystem and across various entities within the ecosystem. Various embodiments reduce errors and associated fees through use of verifiable asset information/data. Various embodiments record relevant and new asset information/data in the distributed ledger with a clear indication of users assigned and/or associated with each asset. Various embodiments provide for capturing asset information/data that has not been traditionally captured (e.g., the capturing of assignment data prior to the submission of an IDR corresponding to the IP asset). Various embodiments provide increased transactional efficiency by providing seamless and quick submission of documents and/or asset information/data between entities that are members of the distributed ledger system 100. For example, various embodiments reduce intermediaries and fees associated therewith. In another example, the exchange of value (e.g., corresponding to the licensing and/or sale of IP assets) between entities that are members of the distributed ledger system 100 is conducted through smart contracts, in an example embodiment. Various embodiments provide for increased collaboration between entities that are members of the distributed ledger system 100 and between users within a member entity (e.g., collaboration between users/employees/inventors and users that are part of the legal team and/or intellectual property team). For example, various embodiments encourage the improved sharing of knowledge about IP assets throughout the IP asset ecosystem.

In various embodiments, a distributed ledger has a plurality of members. Each member may be an entity such as an individual, organization, department of a corporation, corporation, and/or the like. Each member may have one or more users and/or user profiles associated therewith. For instance, a user may be an employee of a member entity. Each user profile may be associated with a use identifier configured to identify the user (e.g., employee identification number, user's name, and/or the like), a member entity identifier configured to identify the member entity corresponding to the user, a role indicator configured to indicate a role corresponding to the user's position at the member entity, one or more project identifiers each identifying a project the user is assigned to, and/or the like. Some example roles include employer, administrator, employee, inventor, legal team, assignor, assignee, licensor, licensee, lessor, lessee, and/or the like. In an example embodiment, a role indicator may indicate the role of the user within the member entity and one or more projects assigned to the user. In various embodiments, the permissioning/access control module 426 of the distributed ledger system 100 may be configured to use the user identifier, member entity identifier, and/or role indicator to determine types and/or instances of asset information/data that a user may access. In various embodiments, the user profiles may be stored in the distributed ledger, by a user profile database and/or module of the ledger protocol layer 420, and/or in a separate manner. For example, each member entity may store a user profile database (e.g., stored in a provider computing entity 40 and/or the like) comprising user profiles corresponding to the users associated with the member entity.

In various embodiments, member entities may be able to purchase and/or license for use one or more computer programs and/or applications via the distributed ledger system 100 that provide functionality that may use the asset information/data stored in the distributed ledger. For example, a member entity may purchase and/or license for use a computer program and/or application via the distributed ledger system 100 configured to allow a user to compare IP asset portfolios, participate in fractional trading and/or investment in IP assets, perform various analyses of asset information/data stored in the distributed ledger, perform various docketing procedures, and/or the like. In an example embodiment, one or more of the computer programs and/or applications available for purchase and/or licensing for use via the distributed ledger system 100 may be configured to gain added value from asset information/data stored in and/or recorded to the distributed ledger. For example, one computer program and/or application may be configured to receive (e.g., via user interaction with an IUI provided via a user interface of a user computing entity 30) information/data identifying an IP asset portfolio (e.g., an IP asset portfolio owned by a member entity corresponding to the user), identify one or more similar IP asset portfolios (e.g., similar in term age, countries filed, renewal rates, and/or other properties), generate a comparison between the IP asset identified by the user input and the one or more similar IP asset portfolios for a plurality of criteria, and provide the comparison for user consumption via the IUI. In an example embodiment, information/data regarding the one or more similar IP asset portfolios is provided in an anonymous manner (e.g., identifying information/data regarding the owner of a similar IP asset portfolio and/or one or more IP assets within the portfolio may not be provided).

Various aspects of the operation of the distributed ledger system 100 and aspects of the distributed ledger system corresponding to providing asset information/data and/or an evaluation value for an IP asset for valuing the IP asset as part of one or more financial instruments and/or determining risk associated with the IP asset as part of one or more financial instruments will now be described in more detail. In various embodiments, the one or more financial instruments may include secured assets, backed securities, licensing of an IP asset, securitizing a license stream (e.g., similar to a mortgage-backed security backed by an IP asset), one or more financial derivatives, and/or the like.

a. Financial Instrument Applications of Distributed Ledger System 100

Various embodiments provide a distributed ledger system 100 configured to capture and record asset information/data regarding one or more IP assets (and/or other intangible assets). Various embodiments provide a distributed ledger system 100 configured to generate and/or record an evaluation value corresponding to an IP asset (and/or other intangible asset). Various embodiments provide a distributed ledger system 100 configured to provide asset information/data and/or an evaluation value for an IP asset for use in valuing the IP asset as part of one or more financial instruments and/or determining risk associated with the IP asset as part of one or more financial instruments. In various embodiments, the one or more financial instruments may include secured assets, backed securities, licensing of an IP asset, securitizing a license stream (e.g., similar to a mortgage-backed security backed by an IP asset), one or more financial derivatives, and/or the like. In an example embodiment, the value, risk, and/or the like corresponding to an IP asset may be based on a category corresponding to the IP asset, wherein the categories comprise prime IP assets (e.g., having a good and steady corresponding revenue stream), sub-prime IP assets (e.g., having a low, unreliable, and/or unknown corresponding revenue stream), and unknown IP asset (e.g., having no corresponding revenue stream). In various embodiments, the revenue stream corresponding to an IP asset include licensing revenue, sales revenue, savings, and/or the like corresponding to the IP asset. Various embodiments provide a distributed ledger system 100 for storing instrument information/data corresponding to an IP asset. In various embodiments, asset information/data may include assignment information/data, innovation disclosures (e.g., IDRs), grant/issue information/data, maintenance and/or expiry information/data, search and/or due diligence investigation information/data, licensing/sale information/data, litigation/legal proceeding information/data, evaluation values, instrument information/data, and/or the like corresponding to an IP asset (and/or other intangible asset).

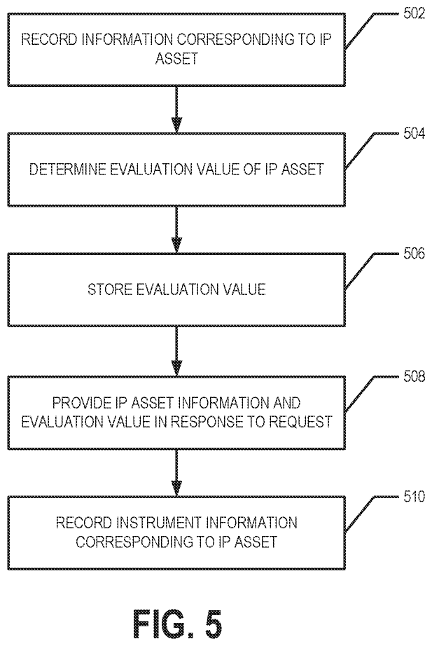

FIG. 5 provides a flowchart illustrating processes, steps, procedures, operations, and/or the like for utilizing information/data and/or an evaluation value corresponding to an IP asset to perform one or more financial instrument-related functions, according to an example embodiment. Starting at step/operation 502, asset information/data corresponding to an IP asset may be received and recorded to the distributed ledger of the distributed ledger system 100. For example, a user executing a user computing entity 30 may interact with an IUI (e.g., provided via IUI module 412) to provide asset information/data corresponding to an IP asset. The user computing entity 30 may provide (e.g., transmit) the asset information/data such that a node computing entity 200 receives the asset information/data. The node computing entity 200, 200′ may then initiate a voting and/or consensus process (e.g., via consensus/voting module 422) to cause the asset information/data to be recorded to the distributed ledger of the distributed ledger system 100 (e.g., written to local ledger files 432 of a plurality of node computing entities 200, 200′). Additional details regarding the receiving and recording of asset information/data to the distributed ledger of the distributed ledger system are provided in Appendix A.

At step/operation 504, an evaluation value of the IP asset may be determined. For example, a machine user may automatically, periodically, and/or in response to a trigger (e.g., new asset information/data corresponding to the IP asset being recorded to the distributed ledger) access asset information/data corresponding to the IP asset from the distributed ledger and/or one or more sources external to the distributed ledger and determine an evaluation value of the IP asset. In various embodiments, the evaluation value is determined based on the strength of the IP asset, the actual income and/or savings corresponding to the IP asset, the expected income and/or savings corresponding to the IP asset, litigation and/or prosecution history corresponding to the IP asset, and/or the like. In various embodiments, the evaluation value of the IP asset may be determined based at least in part on evaluation information/data provided by one or more human evaluators. Additional details regarding determining an evaluation value of an IP asset are provided in Appendix B.

At step/operation 506, the evaluation value of the IP asset is recorded to the distributed ledger. For example, if a machine user operating on a user computing entity 30 determines the evaluation value of the IP asset, the user computing entity 30 may provide (e.g., transmit) the evaluation value of the IP asset such that a node computing entity 200, 200′ of the distributed ledger system 100 receives the evaluation value of the IP asset. The node commuting entity 200, 200′ may then initiate a voting and/or consensus process (e.g., via consensus/voting module 422) to cause the evaluation value of the IP asset to be recorded to the distributed ledger of the distributed ledger system 100 (e.g., written to local ledger files 432 of a plurality of node computing entities 200, 200′).

At step/operation 508, in response to a request (e.g., provided by an appropriately credentialed provider computing entity 40 and/or by a provider computing entity 40 being operated by a user corresponding to a user profile having appropriate permissions) asset information/data corresponding to the IP asset and/or the evaluation value of the IP asset may be provided. For example, a node computing entity 200, 200′ may receive a request that was generated by a provider computing entity 40 requesting asset information/data and/or an evaluation value corresponding to an IP asset. The node computing entity 200, 200′ may ensure that the request corresponds to a provider computing entity 40 and/or user profile having appropriate permissions for accessing the requested information/data (e.g., via the permissioning/access control module 426). The node computing entity 200, 200′ may then access the requested information/data (e.g., asset information/data and/or evaluation value of the IP asset) from the distributed ledger and provide (e.g., transmit) the requested information/data such that the provider computing entity 40 receives the requested information/data. In an example embodiment, the requested information/data is provided in an encrypted and/or otherwise secured manner.

In various embodiments, the provider computing entity 40 may use the requested information/data (e.g., asset information/data and/or evaluation value for the IP asset) to perform one or more determinations, calculations, and/or the like corresponding to a financial instrument comprising at least a portion of and/or related to the IP asset. For example, the provider computing entity 40 and/or a user of the provider computing entity 40 may use the evaluation value and/or asset information/data corresponding to the IP asset to value the IP asset as part of one or more financial instruments, determine risk associated with the IP asset as part of one or more financial instruments, and/or the like. In various embodiments, the one or more financial instruments may include secured assets, backed securities, licensing of an IP asset, securitizing a license stream (e.g., similar to a mortgage-backed security backed by an IP asset), one or more financial derivatives, and/or the like. In an example embodiment, the value, risk, and/or the like corresponding to an IP asset may be based on a category corresponding to the IP asset, wherein the categories comprise prime IP assets (e.g., having a good and steady corresponding revenue stream), sub-prime IP assets (e.g., having a low, unreliable, and/or unknown corresponding revenue stream), and unknown IP asset (e.g., having no corresponding revenue stream). In various embodiments, the revenue stream corresponding to an IP asset include licensing revenue, sales revenue, savings, and/or the like corresponding to the IP asset.

In various embodiments, the provider computing entity 40 may provide instrument information/data corresponding to the financial instrument comprising at least a portion of and/or related to the IP asset such that a node computing entity 200, 200′ receives the instrument information/data. For example, the instrument information/data may indicate terms and conditions of the corresponding financial instrument, identify the related IP asset(s) (e.g., via corresponding asset identifiers), indicate a type of the financial instrument, indicate a status of the financial instrument, a start date, a maturation date, and/or the like. The node computing entity 200, 200′ may then initiate a voting and/or consensus process (e.g., via consensus/voting module 422) to cause the instrument information/data to be recorded to the distributed ledger of the distributed ledger system 100 (e.g., written to local ledger files 432 of a plurality of node computing entities 200, 200′) at step/operation 510.

In various embodiments, the IUI may enable a user (e.g., corresponding to a user profile having the appropriate permissions) to access the instrument information/data recorded to the distributed ledger. In various embodiments, one or more smart contracts 424 may be used to execute one or more transactions corresponding to and/or involving the financial instrument and/or performing one or more processes corresponding to the financial instrument.

b. Technical Advantages

Various embodiments provide a variety of technical improvements. For instance, various embodiments provide a technical solution to the technical problem of managing, verifying, and providing asset information/data and/or evaluation values corresponding to one or more IP assets in a manner that provides verified and/or verifiable information/data in an access controlled manner. For example, various embodiments provide for the leveraging of verified and/or verifiable asset information/data and/or evaluation value for one or more IP assets for valuing the IP asset as part of one or more financial instruments, determining risk associated with the IP asset as part of one or more financial instruments, and/or the like. In various embodiments, the one or more financial instruments may include secured assets, backed securities, licensing of an IP asset, securitizing a license stream (e.g., similar to a mortgage-backed security backed by an IP asset), one or more financial derivatives, and/or the like. In an example embodiment, the value, risk, and/or the like corresponding to an IP asset may be based on a category corresponding to the IP asset, wherein the categories comprise prime IP assets (e.g., having a good and steady corresponding revenue stream), sub-prime IP assets (e.g., having a low, unreliable, and/or unknown corresponding revenue stream), and unknown IP asset (e.g., having no corresponding revenue stream). In various embodiments, the revenue stream corresponding to an IP asset include licensing revenue, sales revenue, savings, and/or the like corresponding to the IP asset.

In various embodiments, the distributed ledger system 100 provides transparent, accurate, and comprehensive asset information/data, evaluation value, and/or instrument information/data corresponding to an IP asset. For example, various embodiments provide enhanced traceability of assets through the asset lifecycle in the overall ecosystem. For example, various embodiments provide enhanced traceability of IP assets through the IP asset lifecycle in the overall IP ecosystem. Various embodiments provide improved transactions, minimize reputational risk, and provide improved accessibility to asset information/data. Thus, various embodiments of the distributed ledger system 100 and the corresponding IUI provide technical improvements in the field of distributed ledger systems, IUIs, asset information/data capture and management, asset evaluation value determination, and/or the leveraging of such for performing tasks corresponding to a financial instrument comprising at least a portion of and/or related to an IP asset.

### V. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
receiving and recording, by one or more node computing entities, asset information/data in a distributed ledger of a distributed ledger system, the asset information/data corresponding to an IP asset;
providing, by one or more node computing entities, asset information/data for use in determining an evaluation value of the IP asset;
recording, by the one or more node computing entities, the evaluation value of the IP asset to the distributed ledger;
providing, by the one or more node computing entities, at least a portion of the asset information/data and/or the evaluation value of the IP asset for use performing one or more tasks corresponding to a financial instrument related to the IP asset; and
receiving and recording, by the one or more node computing entities, instrument information/data corresponding to the financial related to the IP asset.

2. The method of claim 1, wherein the financial instrument is a secured asset, backed security, licensing of an IP asset, securitizing a license stream, or a financial derivative.

3. The method of claim 1, further comprising performing one or more transactions corresponding to a financial instrument via a smart contract executing in the distributed ledger system.

4. The method of claim 1, wherein the IP asset is an individual IP asset, an unrelated plurality of IP assets, a family of IP assets, or a portfolio of IP assets.

5. The method of claim 1, wherein the one or more tasks corresponding to the financial instrument comprise at least one of valuing the IP asset as part of one or more financial instruments or determining risk associated with the IP asset as part of one or more financial instruments.

6. A method comprising:
accessing asset information/data and/or an evaluation value corresponding to an IP asset from a distributed ledger of a distributed ledger system; and
leveraging the asset information/data and/or evaluation value to perform one or more tasks corresponding to a financial instrument related to (e.g., incorporating) the IP asset.

8. A computing system comprising a non-transitory computer readable storage medium storing computer executable code and one or more processors, the computing system configured to perform the method of claim 1.

9. A computer program product comprising a non-transitory computer readable medium having computer program instructions stored therein, the computer program instructions, when executed by a processor of a computing entity, cause the computing entity to perform the method of claim 1.
